(19) United States
(12) Patent Application Publication
(10) Pub. No.: US 2008/0193744 A1
(43) Pub. Date: Aug. 14, 2008

(54) Changing the State of a Body of Material

(75) Inventors: Keith Fawdington, Loughborough Leicestershire (GB); Paul Tranter, Leicestershire (GB)

Correspondence Address: BROOKS KUSHMAN P.C., 1000 TOWN CENTER, TWENTY-SECOND FLOOR, SOUTHFIELD, MI, 48075, US

(73) Assignee: UVASOL LIMITED, Loughborough Leicestershire (GB)

(21) Appl. No.: 11/816,546

(22) PCT Filed: Feb. 18, 2006
(86) PCT No.: PCT/GB06/50041

§ 371 Date: Oct. 6, 2007

(30) Foreign Application Priority Data
Feb. 18, 2005 (GB) 0503425.1

(51) Int. Cl. C08F 2/48; B32B 7/00

(52) U.S. Cl. 428/332; 427/508

(57) ABSTRACT

A body (2) of UV settable polymer material is quickly cured to a solid state by applying UV radiation from a lamp (4). The polymer is mixed with strands (3) of optical fibres. The radiation is able to penetrate up to 3 mms through the polymer allowing it to enter the optical strands and to pass between adjoining strands so as to penetrate uniformly the whole of the polymer body. The optical strands can be designed so that they leak radiation from their sides thereby assisting in the transfer of radiation from a strand into the polymer and into other strands. In an alternative arrangement the strands can be longer and possibly woven or otherwise formed into a mat of fibres sufficiently close to allow radiation to pass between them. Because the radiation passes from one fibre to another, it can be introduced through only one or a selection of the fibres.

This invention relates to methods for changing the state of a body of material. It arose when considering difficulties associated with the use of conventional two-part filler for repairing motor vehicle body panels. Conventional filler used for this purpose comprises a polyester resin containing up to 20% styrene as a cross linking agent. Immediately before use, the resin is mixed with an isocyanate called Di-benzyl Peroxide. This is the “hardener.” It acts by triggering a chemical reaction during which the styrene creates a three dimensional interlocking network resulting in hardening or “curing” of the resin.

The speed of the curing process is highly dependant on the amount of hardener added and on temperature. For this reason, it frequently happens that either insufficient hardener is added and the resin does not cure; or that too much is added and hardening takes place before the mixture has been applied to the work. A further problem is that, after mixing, the filler must be used within a short period of time. This results in inevitable waste because it is impossible to predict in advance exactly how much material will be needed. It also means that the work (including the mixing process) may need to be hurried to ensure completion before hardening occurs.

The materials used in this conventional process present a health hazard. The isocyanate is classified as an irritant and the styrene materials used in the resin can cause dermatitis and are classified as harmful. Furthermore, it is usual to finish the repair using an abrasive power tool to remove excess filler and to leave a smooth finish. The resulting dust can cause lung disease if precautions are not taken to prevent inhalation.

Patent specification US 2004/0021255 (the content of which is imported into this specification by reference) describes a method of making plastics components from resins mixed with photo initiators so that they can be cured by the application of radiation, particularly ultraviolet radiation. This earlier publication describes a technique in which optical fibres are embedded in the resin. The fibres are designed to leak radiation along their lengths; allowing UV or other radiation fed into one end of a fibre to be distributed into the body of the resin rather than, as would be conventional, being just irradiated onto the outer surface.

The process described in US 2004/0021255 has the potential to work well. However, it requires the provision of optical fibre matting, custom made for the article to be manufactured. It also requires each of the UV transmitting fibres of the matting to be so arranged that it leads to a source of radiation. For these reasons, the teachings of US 2004/0021255 are impracticable for use in many environments, including the repair of motor vehicle body parts as referred to above. The present invention allows the aforementioned problems to be overcome.

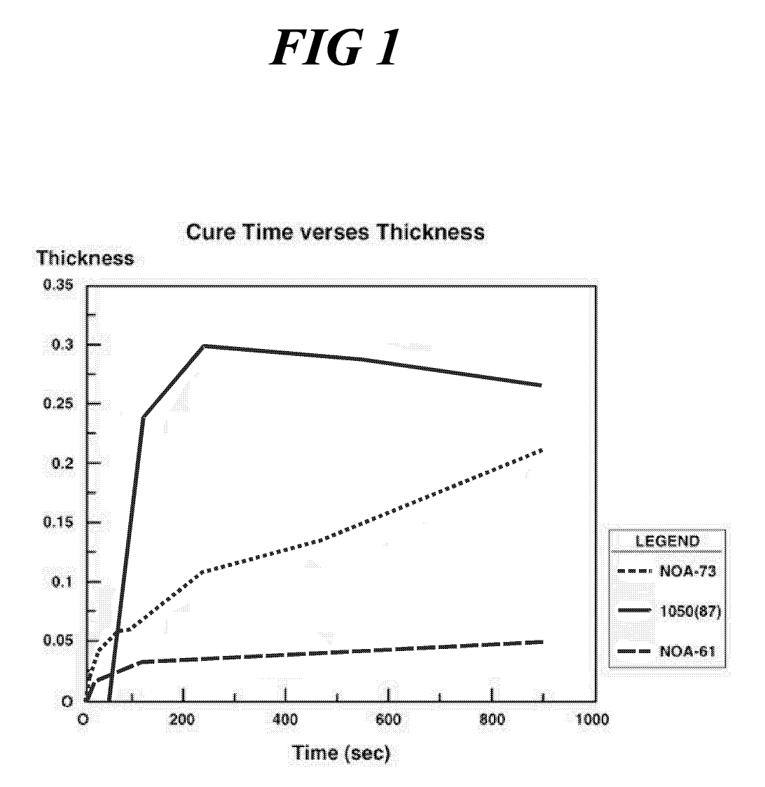

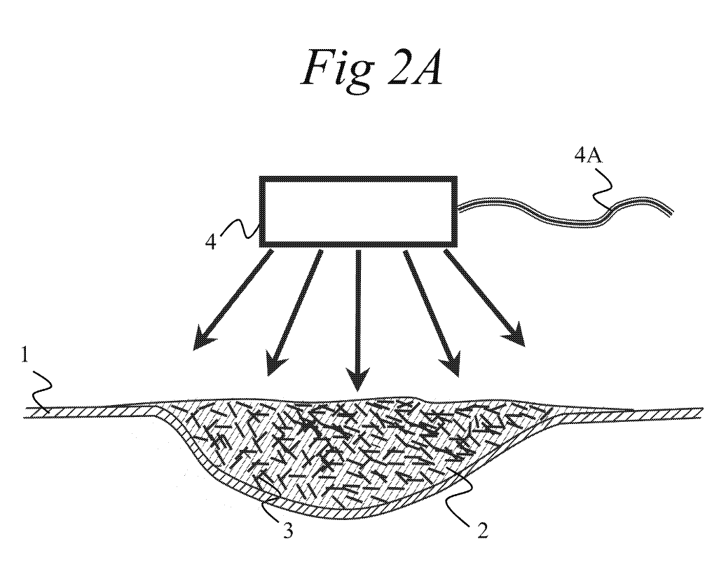

The publication “Mechanisms Relating to Reducing Stress in Curing Thick Sections of UV Adhesives” by Eric A Norland and Frank S Martin, of Norland Products Inc., North Brunswick, N.J. 08902 (the content of which is imported into this specification by reference) studies the ability of UV radiation to penetrate different resins/adhesives supplied by Norland Products under type numbers NOA-73, 1050(87) and NOA-61. FIG. 1 of the accompanying drawings reproduces their experimental results for three of their products. It will be understood that the speed of curing will depend on the resin used and the amount and type of photo initiator used. The results shown on FIG. 1 for the compound NOA-73 appears to indicate that the radiation will penetrate through thicknesses of up to 3 mms. The downward slope towards the right hand side of the graph for 1050(87) suggests a margin of error of about 0.3 to 0.5 mms. and subsequent references to the 3 mm dimension in this specification are to be taken as being subject to this 0.5 mm margin of error. The other two graphs, for NOA-73 and NOA-61 are not helpful in indicating the maximum depth of penetration and are included only for completeness of reporting the author's experimental results; but it seems reasonable to speculate that the values for all suitable materials will be similar i.e. about 3 mms±0.5 mms.

The present invention arose from the realisation that this ability of UV radiation to penetrate up to 3 mms of the polymer/resin allows many of the limitations of US 2004/0021255 to be overcome.

The invention provides a method of changing the state of a settable body of material by embedding an optically conductive element in the material, transmitting radiation along the optically conductive element and allowing the radiation to escape from the said element and into the settable material thereby facilitating the change of state characterised in that the radiation is introduced into the optically conductive elements after penetrating through some of the material.

The invention can be implemented in either one or both of two distinct ways. The first possibility is for the optically conductive element (this will normally be an optical fibre) to be located close to the surface, and preferably within the 3 mm limit referred to above. This allows radiation directed onto the surface of the body to enter the fibre and thereby to be distributed deeper into the body of settable material. The second possibility is for different fibres to be arranged, in the body, sufficiently closely that radiation issuing from one, will traverse the space between them (which of course should be about 3 mm or less).

In one preferred method employing the invention a large number of chopped strands of optical fibre are mixed with the settable material in a quantity such that radiation can propagate throughout the body of material by making jumps of less than 3 mms between strands. This result could possibly be achieved by absorption and emission of radiation from the ends of the chopped fibre strands. It is considered better however to use fibres that are specially designed to leak or absorb radiation through their sides in a manner eg as described in US 2004/0021255.

Where chopped strands are employed, as described above, it is possible to provide a convenient ready mixed composition that can easily be a) applied in the required quantity to a component such as a damaged motor vehicle panel, b) worked at leisure to the required shape without risk of premature setting, c) irradiated with a portable eg hand-held ultraviolet lamp so as to set the composition in a period of seconds, and e) smoothed with a powered abrasive tool without producing dust containing specially harmful dust.

It is believed that electromagnetic radiation anywhere from about 100 to 800 nm could potentially be used, i.e. anywhere between and including ultraviolet and visible red light, since photo initiators are known which will perform throughout this range. UV-A radiation (between about 320 nm to 420 nm) is preferred because this is known to be relatively harmless and can activate suitable photo-initiators to achieve rapid curing.

Although the invention arose for particular use in the specialist field of repairing motor vehicle body panels, it is not limited to this field, and it is now believed that the invention may have far reaching applicability to the manufacture of many articles from UV or other radiation-curable polymers

The term “optical” is used in this specification to include any electromagnetic radiation. It is envisaged that glass fibre, (preferably coated) will normally be used but there are other possibilities, such as polymethylmethacrylate. The material does not necessarily have to be fibrous; it may be possible to obtain the desired effect by the inclusion of relatively rigid pieces of material, which could be rod-like or otherwise shaped so as to form a waveguide operating by total internal reflection.

In circumstances where it is acceptable to have an optical lead into the body of material, as described in US 2004/0021255, it becomes possible, by using the invention, to reduce, ultimately to one, the number of fibres needed to form this optical lead. It is merely necessary to arrange the fibres within the settable material with the 3 mm or less spacing so as to allow passage of radiation from the optical “lead” fibre into and between the other fibres.

Instead of using the chopped fibres described previously, it would be possible instead, to employ longer fibres, it being only necessary that the fibres are designed and arranged in sufficient proximity to give the required spacing to permit transfer of radiation between them. The fibres can be woven, knitted or otherwise formed into a mat or preform, possibly together with fibres of other material for reinforcement purposes.

Where required, leakage of radiation through the fibre wall can be achieved in a variety of ways. For example, the coating on a conventional fibre could be removed or deliberately damaged so that it allows radiation to escape along its length. An alternative technique is to employ optical fibre which is crimped or bent beyond the maximum angle at which total internal reflection can be assured. In this way, radiation can be permitted to escape or to be introduced into the fibre at each bend. Another possibility would of course to manufacture the fibre with a specially designed coating, or entirely without a coating to allow the required radiation leakage. Where an optical “lead” fibre is used as previously described, this is preferably designed so that an increasing proportion of the radiation is allowed to escape with increasing distance from the radiation source thereby equalising or otherwise controlling the amount of radiation emitted over all parts of the fibre.

Examples of how the invention can be employed will now be described by way of example with reference to the accompanying drawings, in which:—

FIG. 1 illustrates the relationship between the thickness of a body of UV curable polymer and the time taken for it to cure.

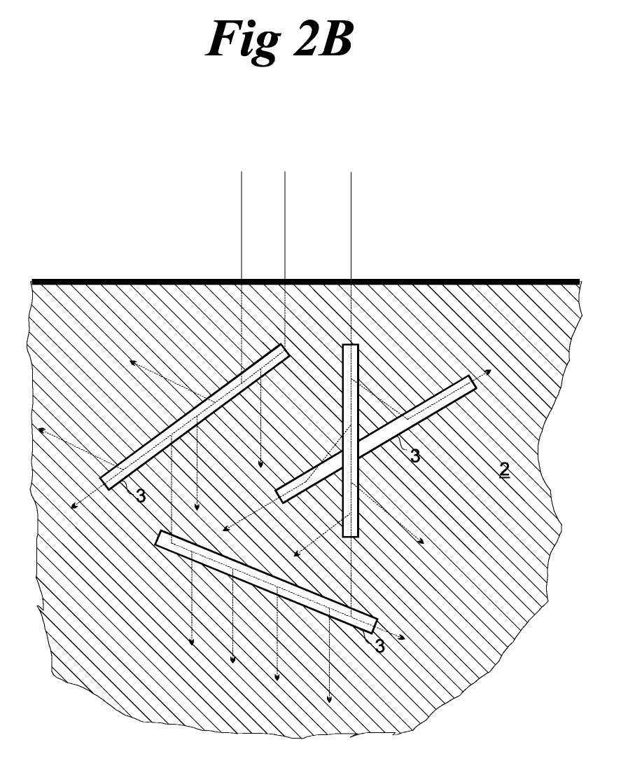

FIG. 2A shows a cross-section through a dent in a motor vehicle body panel being repaired using a method in accordance with the invention;

FIG. 2B shows a detail of FIG. 2A.

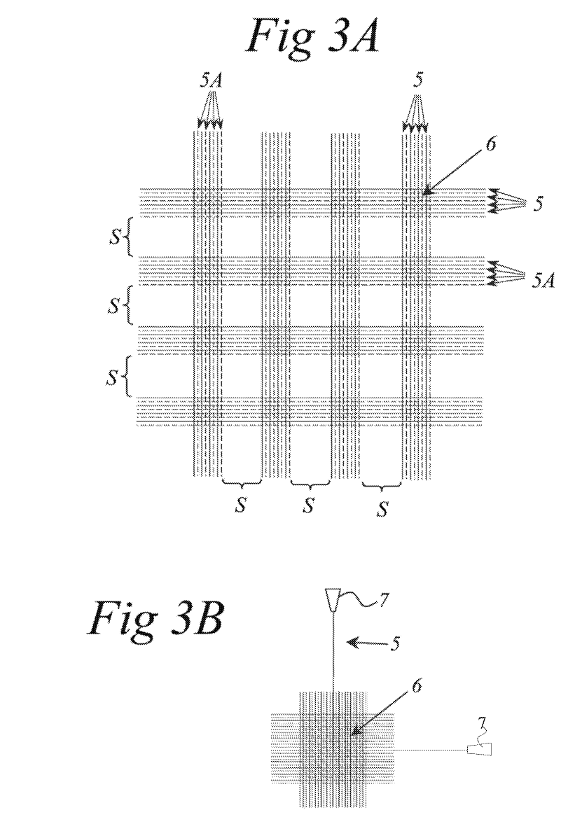

FIGS. 3A and 3B illustrate schematically the manufacture of rectangular matting or “preforms” for use in processes employing the invention;

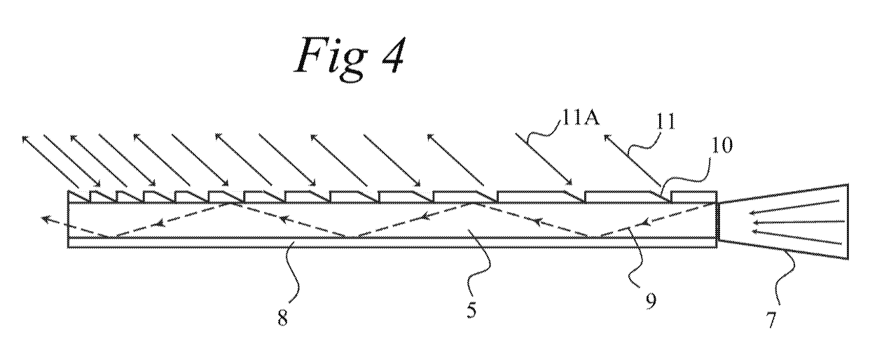

FIG. 4 shows a detail of a length of glass fibre used in the matting of FIGS. 3A and 3B; and

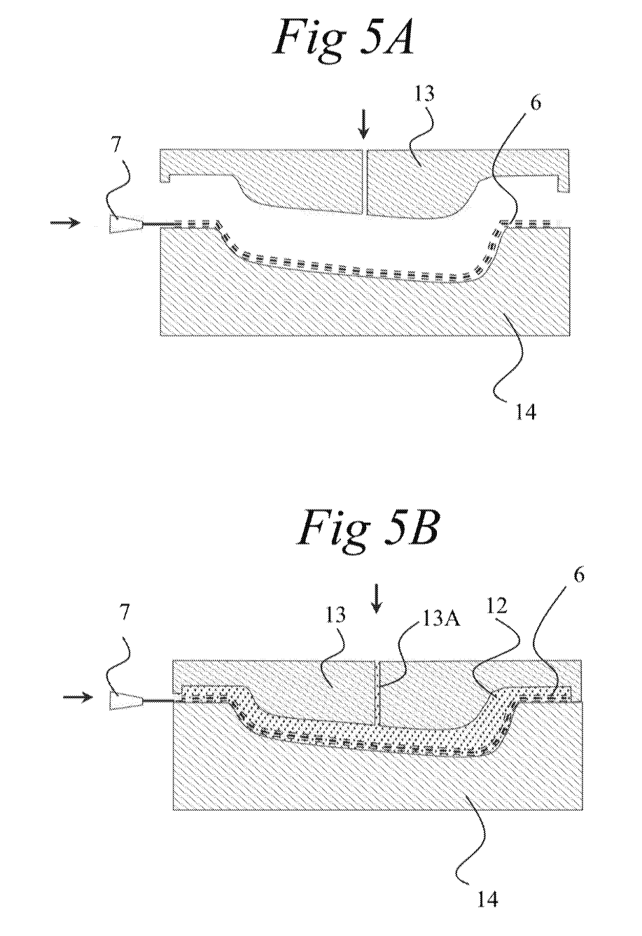

FIGS. 5A and 5B show the manufacture of a moulded object using the matting of FIG. 3B.

Referring first to FIG. 2A, this shows a repair being carried out to a dented motor vehicle body panel 1. The dent is filled proud with a paste 2 consisting of a thixotropic polyester mixed with a filler and a photo-initiator. The polyester, which in this example is an acrylic or methacrylic ester, is mixed with an inert powder such as chalk and with Benzophenone as a photo-initiator, the latter forming 1 to 20% by weight of the total mixture. Other photo-initiators can be used and the following table gives examples, including Benzophenone.

| Electron Transfer Photo- | |
|---|---|
| initiators | Photo-fragmentation Photo-initiators |
| Benzophenone | Alkyl ethers of benzoin |
| Diphenoxy benzophenone | Benzil dimethyl ketal |
| Halogenated and amino | 2-hydroxy-2-methylphenol-1-propanone |
| functional benzophenones | |
| Fluorenone derivatives | 2,2-diethoxyacetophenone |
| Anthraquinone derivatives | 2-benzyl-2-N, |
| Zanthone derivatives | Halogenated acetophenone derivatives |
| Thioxanthone derivatives | Sulfonyl chlorides of aromatic |
| | compounds |
| Camphorquinone | Acylphosphine oxides and bis-acyl |
| | phosphine oxides |
| Benzil | Benzimidazoles |
| Benzophenone | Alkyl ethers of benzoin |
| Diphenoxy benzophenone | Benzil dimethyl ketal |
| Halogenated and amino | 2-hydroxy-2-methylphenol-1-propanone |
| functional benzophenones | |
| Fluorenone derivatives | 2,2-diethoxyacetophenone |
| Anthraquinone derivatives | 2-benzyl-2-N,N-dimethylamino-1-(4- |
| | morpholinophenyl) butanone |
| Zanthone derivatives | Halogenated acetophenone derivatives |
| Thioxanthone derivatives | Sulfonyl chlorides of aromatic |
| | compounds |
| Camphorquinone | Acylphosphine oxides and bis-acyl |
| | phosphine oxides |
| Benzil | Benzimidazoles |
| Benzophenone | Alkyl ethers of benzoin |
| Diphenoxy benzophenone | Benzil dimethyl ketal |
| Halogenated and amino | 2-hydroxy-2-methylphenol-1-propanone |
| functional benzophenones | |

This paste is mixed with chopped lengths 3 of glass fibre. The fibres are coated, as is conventional, to obtain total internal reflection of the radiation passing along them but the coating is deliberately damaged by passing the fibre, before chopping, through a nip defined between rollers having slightly non-parallel axes. This allows a limited amount of radiation to pass out of or into the fibre at positions along its length. The fibres are arranged generally randomly so that many adjacent fibres make acute angles with each other, facilitating the exchange of radiation between them. The fibres are in sufficient quantity to ensure that (a) a substantial length of fibre is within 3 mms of the surface and (b) most of the total fibre length is within 3 mms of at least one other fibre. Occasional fibres might extend to or project from the surface.

FIG. 2B illustrates examples of the paths that radiation takes into the ends or sides of the fibres; and out of the ends and surfaces of the fibres with the result that the radiation is eventually propagated in all directions through the settable material 2 where it is eventually absorbed so as to cause photo initiation of the curing process.

The chopped fibre strands 3 used in the process of FIGS. 2A and 2B allow the filler to be sprayed into position from a pneumatic spray gun of a type conventionally used for applying resin mixes. However, in other situations, it may be preferable to use one or more longer strands of fibre defining a tangled network of continuous fibre.

When the dent has been filled to the satisfaction of the person performing the repair, the mixture is illuminated with ultraviolet-A radiation filtered to remove potentially harmful wavelengths of around 320 nm. The radiation is supplied from a hand-held flood lamp 4 (FIG. 1), powered via a cable 4A, giving an output power of 44 W and an intensity on the surface of the mixture of 175 to 225 mW cm⁻². Suitable lamps are available from suppliers such as De Montfort Advanced Technologies Ltd. The radiation is capable of penetrating through 3 mms of the mixture. Because the fibres are, in general, closer than 3 mms to each other, and because some of them are within 3 mms of the surface, the radiation is absorbed into the matrix of fibres and distributed by them so as to reach all parts of the polyester/photo-initiator mixture. The result is that the filler solidifies so quickly that a finishing process can be performed immediately.

Finally, the top surface of the solidified polyester filler is smoothed flush with the adjoining panel surface, using conventional abrasive techniques. Any dust released during this process is notably less harmful than the dust of conventional two-part styrene/isocyanate mixtures.

Instead of employing short lengths of fibre as shown in FIGS. 2A and 2B it is possible to embed optically conductive matting into the filler. FIG. 3A shows a process for making suitable mats by weaving optical fibres 5, shown in continuous lines, and interspersed fibres of other reinforcing material such as carbon fibre 5A (shown in broken lines) together. In FIG. 3A, spaces(s) are left along the total lengths of the warp and weft so that a large number of mats 6 are formed in a single weaving operation. For each mat, all the loose warp fibre ends are removed except for one (or in an alternative arrangement a few) of the optical fibres 5 which act as “lead” fibre. The weft fibres are treated similarly. In use, the radiation is directed, using conventional funnel shaped concentrators 7, into the lead fibre ends. Because of the close proximity of the lead fibre(s) to other parallel fibres of the mat, energy is exchanged between the fibres and distributed via all the fibres substantially uniformly throughout the body of filler.

FIG. 4 shows how an optical fibre like that shown at 5 on FIG. 3B can be designed so to distribute energy even more uniformly through the settable material. Radiation is introduced through the concentrator 7 and the optical fibre 5 has a coating 8 of a material having a refractive index which ensures that radiation 9 undergoes total internal reflection. The coating is grooved, eg as shown 10, to allow some of the energy to escape as illustrated by the arrows 11. It will be noted that, in this particular arrangement, the spacing of the grooves 10 decreases towards the downstream end of the fibre so that an approximately equal amount of radiation is emitted from any given length of fibre. Of course, appropriate modification would be needed if a source of radiation were positioned at both ends. The grooves can be made during manufacture of the fibre but it may be more appropriate to form them after weaving of the mats so that a greater or lesser number of grooves can easily be made at appropriate positions of the mat. Because there is no need for the grooves to be optically perfect, it is a simple matter to make them by stamping, abrading or otherwise spoiling the fibres after the mat has been made. Fibres of the mat that are not directly connected to the source of radiation are manufactured in a similar way except that the grooves 10 are uniformly spaced. The arrows 11A on FIG. 3 show how these grooves allow radiation from other fibres to be absorbed as well as allowing radiation to be emitter from the walls of the fibres.

FIGS. 5A and 5B show the manufacture of a moulded component 12 using top and bottom mould parts 13 and 14 respectively. One of the mats 6, described earlier, is placed on the lower mould as shown on FIG. 5A and the two mould parts are brought together as shown at 5B. UV curable polyester material is then injected into the mould through duct 13A. UV radiation is then fed into the end of one or a selected number of the fibres, causing rapid curing of the polyester. In an alternative method, similar equipment could be used for the manufacture of articles from polyester “dough” which is pressed into the mould with the optical mat before the two mould parts are brought together.

It will be readily apparent that the principle illustrated in FIGS. 5A and 5B allows UV curable materials to be employed in environments where they could not previously be used because the mould parts would prevent the radiation from reaching the workpiece. The invention is therefore of particular value in this type of situation. However it will readily be apparent that the principle of the invention can be used in many other moulding techniques for example:

### Spray Lay-up

### Wet or Hand Lay-up

Vacuum bagging
Pressure forming
Stamp forming
Filament winding

### Pultrusion

Resin Transfer moulding
Resin infusion
Prepreg moulding

### Autoclave Moulding and

Resin film infusion.

1. A method of changing the state of a settable body of material by embedding an optically conductive element in the material, transmitting radiation along the optically conductive element and allowing the radiation to escape from the said element and into the settable material thereby facilitating the change of state characterised in that the radiation is introduced into the optically conductive elements after penetrating through some of the material.

2. A method according to claim 1 characterised in that the radiation is directed onto a surface of the body and penetrates through the surface and into an optically conductive element.

3. A method according to claim 2 characterised in that the radiation enters the optically conductive element at a position within 3 mms of the surface.

4. A method according to claim 1, characterised in that the radiation is transmitted between optically conductive elements through the settable material.

5. A method according to claim 4 characterised in that the radiation is transmitted along paths of 3 mms or less between the optically conductive elements.

6. A method according to claim 1 characterised in that the or each optically conductive element is an optical fibre.

7. A method according to claim 6 characterised in that the optical fibre is designed to leak the radiation along its length.

8. A method according to claim 6 characterised in that chopped strands of optical fibre are mixed with the material.

9. A method according to claim 6 characterised in that the optical fibre is in the form of a mat or perform of optical fibres, only one or a selection of which, are connected to a source of radiation.

10. A method according to claim 1 characterised in that the body of material is used as a filler and as part of a repair process.

11. A method according to claim 1 characterised in that the wavelength of the radiation is between the wavelengths of 100 to 800 nanometres.

12. A method according to claim 11 characterised in that the wavelength is between the wavelengths of 320 to 420 nanometres.

13. A method according to claim 11 characterised in that the radiation is ultraviolet-A radiation filtered to remove potentially harmful wavelengths of around 320 nm.

14. A body of material made by the method of claim 1 and containing the optically conductive element or elements.

15. A body of material according to claim 14 characterised in that each element is spaced from at least one other element by a distance such as to define a path for radiation between them of not more than about 3 mm.
